(19) United States
(12) Patent Application Publication
(10) Pub. No.: US 2013/0296086 A1
(43) Pub. Date: Nov. 7, 2013

(54) TRACTION DRIVE OF AN INTERNAL COMBUSTION ENGINE AND METHOD FOR OPERATING THE SAME

(71) Applicants: Christian Hauck, Altdorf (DE); Martin Rauch, Hirschaid (DE)

(72) Inventors: Christian Hauck, Altdorf (DE); Martin Rauch, Hirschaid (DE)

(73) Assignee: Schaeffler Technologies AG & Co. KG, Herzogenaurach (DE)

(21) Appl. No.: 13/980,896

(22) PCT Filed: Oct. 26, 2011
(86) PCT No.: PCT/EP2011/068751

§ 371 Date: Jul. 22, 2013

(30) Foreign Application Priority Data
Jan. 27, 2011 (DE) 10 2011 003 225.8

(51) Int. Cl. F02B 67/06; F16H 7/02

(52) U.S. Cl. CPC F02B 67/06; F16H 7/02
USPC 474/87

(57) ABSTRACT

A traction drive of an internal combustion engine and a method for operating the same are proposed. The traction drive includes two parallel drive levels, and as well as a normal operating mode it permits the following operating modes:—starting of the internal combustion engine,—boosting of the internal combustion engine, and—stationary-mode airconditioning.

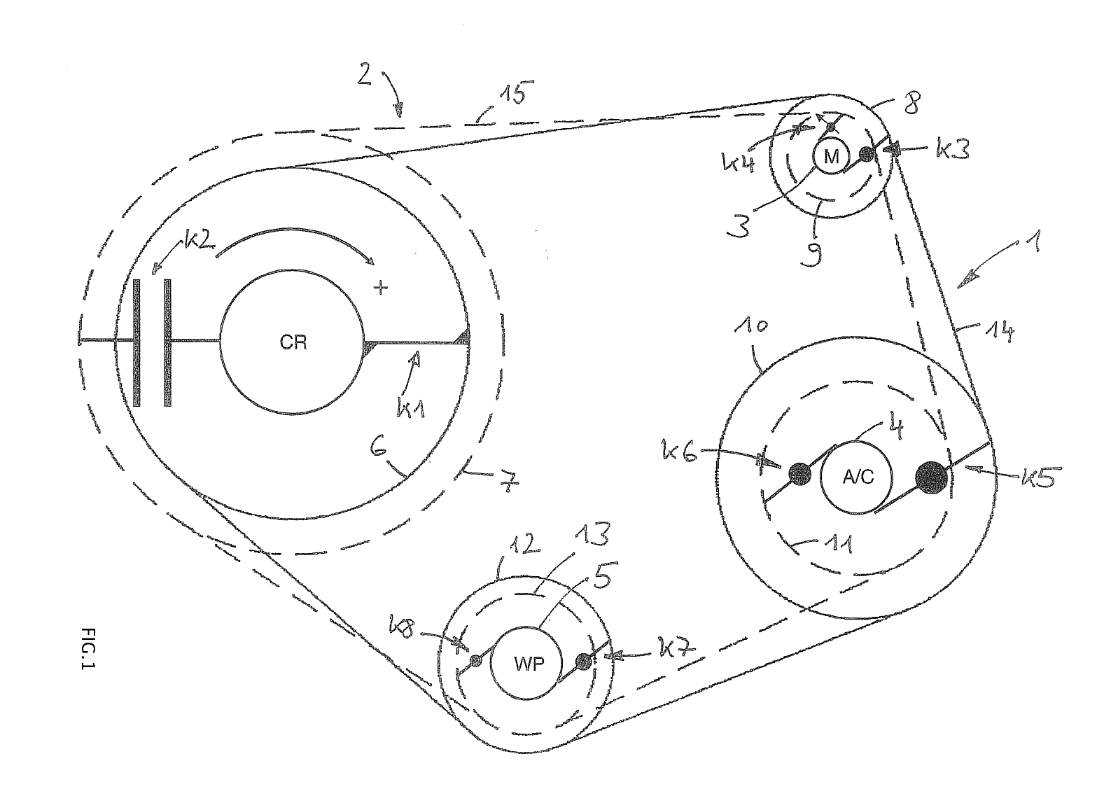

### BACKGROUND

The invention concerns a traction drive of an internal combustion engine, comprising two parallel drive planes and:
a first crankshaft wheel which can be connected rotationally with a crankshaft of the internal combustion engine and is arranged in the first drive plane,
a second crankshaft wheel which can be connected rotationally with the crankshaft and is arranged coaxially to the first crankshaft wheel in the second drive plane,
an electric machine, which can be operated either as a generator or as a motor, with a machine shaft,
a first machine wheel which can be connected rotationally with the machine shaft and is arranged in the first drive plane in order to be driven by the crankshaft when the electric machine is in a generator mode,
a second machine wheel which can be connected rotationally with the machine shaft and is arranged coaxially to the first machine wheel in the second drive plane in order to drive the crankshaft when the electric machine is in a motor mode,
an air-conditioning compressor with a compressor shaft,
a first compressor wheel which can be connected rotationally with the compressor shaft and is arranged in the first drive plane in order to drive the air-conditioning compressor in the generator mode,
an endlessly circulating first traction means which loops around the first wheels arranged in the first drive plane,
and an endlessly circulating second traction means which loops around the second wheels arranged in the second drive plane.

A generic double belt drive is disclosed in DE 10 2010 054 630 Al not published earlier. The electric machine proposed there is driven in the crankshaft rotation direction either as a driven generator or as a driving motor. The motor mode, driving the crankshaft in its direction of rotation, has a starting mode for starting the internal combustion engine and a so-called boost mode in which the crankshaft is driven not only by the internal combustion engine but also by the electric motor in order to increase the torque.

A further motor mode of the electric machine serves for so-called stationary air-conditioning, for cooling the vehicle driven by the combustion engine. In the publication cited, the electric machine drives the air-conditioning compressor, which is adapted for compression operation in both directions of rotation, in the reverse direction of rotation while the internal combustion engine is stopped.

### SUMMARY

The invention is based on the object of specifying an alternative embodiment of a traction drive of the type cited initially and a method for operating such a traction drive.

The object is achieved by a device with the features and method with the features of the invention. Advantageous embodiments of the invention are described below and in the claims.

Accordingly, a second compressor wheel is provided which can be connected rotationally with the compressor shaft and is arranged coaxially to the first compressor wheel in the second drive plane in order to drive the air-conditioning compressor in motor mode. In contrast to the prior art cited above, stationary air-conditioning takes place not by reversing the direction of rotation of the air-conditioning compressor but by coupling in a further compressor wheel in the second drive plane which also serves to drive the crankshaft.

The same drive concept can be provided for a coolant pump driven by the traction drive for cooling the internal combustion engine. Thus the coolant pump, like the air-conditioning compressor, can be driven by the electric machine when the combustion engine is stopped in order to provide the heat exchanger of the vehicle with preheated coolant (stationary heating).

For operation of the traction drive according to the invention, at least one of the following operating modes is proposed:
a starting mode in which the electric machine operated as a motor drives the crankshaft until the internal combustion engine starts,
a normal operating mode in which the electric machine operated as a generator is driven by the crankshaft of the running internal combustion engine,
a boost mode in which the electric machine operated as a motor drives the crankshaft as support while the internal combustion engine is running,
and when the internal combustion engine is stopped, a stationary air-conditioning mode in which the electric machine operated as a motor drives the air-conditioning compressor or where applicable the coolant pump.

The individual operating modes are controlled/regulated by means of various status parameters, in particular of the internal combustion engine, the vehicle interior temperature and the switching state of the controllable couplings.

A preferred traction means for the first drive plane is a poly-V-belt acting by force-fit and for the second drive plane a toothed belt acting by form-fit. A traction means according the invention can nonetheless also be a chain-chain drive or a belt-chain drive. Also further ancillary devices can be provided, where applicable also in further drive planes.

### BRIEF DESCRIPTION OF THE DRAWINGS

Further features of the invention arise from the description below and the sole FIGURE which shows schematically a traction drive according to the invention of an internal combustion engine of a motor vehicle (not shown). The operational direction of rotation of the combustion engine corresponds to the direction marked on the crankshaft CR with a positive prefix.

The traction drive is formed as a double belt drive with two parallel drive planes, wherein the first drive plane 1 is shown as a solid line and the second drive plane 2 as a dotted line.

The traction drive comprises an electric machine M, which can be operated either as a generator or as a motor, with a machine shaft 3, an air-conditioning compressor A/C with a compressor shaft 4, and a coolant pump WP with a pump shaft 5.

The crankshaft CR is connected rotationally with a first crankshaft wheel 6 arranged thereon and with a second crankshaft wheel 7 coaxial to the first.

The machine shaft 3 is connected rotationally with a first machine wheel 8 arranged thereon and with a second machine wheel 9 coaxial to the first.

The compressor shaft 4 is connected rotationally with a first compressor wheel 10 arranged thereon and with a second compressor wheel 11 coaxial to the first.

The pump shaft 5 is connected rotationally with a first pump wheel 12 arranged thereon and with a second pump wheel 13 coaxial to the first.

The first wheels 6, 8, 10 and 12 are arranged in the first drive plane 1, and a first traction means 14 in the form of an endlessly circulating poly-V-belt loops around said wheels. The second wheels 7, 9, 11 and 13 are arranged in the second drive plane 2, and a second traction means 15 in the form of an endlessly circulating toothed belt loops around said wheels. The pretensioning of the traction means 14, 15 can be adjusted by means of tensioning devices not shown.

The respective direction of rotation of the wheels with the associated shafts is configured as follows.

A first coupling K1 is arranged between the first crankshaft wheel 6 and the crankshaft CR and blocks an overrunning by the crankshaft CR in relation to the first crankshaft wheel 6 in the direction of rotation of the crankshaft CR. Thus the rotation of the driven crankshaft CR is initiated in the first drive plane 1 in normal operating mode. The coupling K1 is a rotational coupling rigid in both directions.

A controllable second coupling K2 is arranged between the second crankshaft wheel 7 and the crankshaft CR and in closed state blocks an overrunning by the second crankshaft wheel 7 in relation to the crankshaft CR in the direction of rotation of the crankshaft CR, and in opened state decouples the second crankshaft wheel 7 from the crankshaft CR in both directions of rotation. In starting and boost modes, the coupling K2 is closed and the rotation of the driving electric machine M is then transmitted to the driven crankshaft CR. In normal operating mode, coupling K2 is opened in order to be able to hold the second drive plane 2 at a standstill. In stationary air-conditioning mode however, coupling K2 is opened in order to be able to hold the crankshaft CR at a standstill. Coupling K2 is an electrically controllable magnetic coupling which can be opened or closed when not powered, and the coupling intervention of which can act by force- or form-fit. Alternatively a controllable overrun coupling can be provided which in opened state allows a relative twist in both directions of rotation.

A third coupling K3 is arranged between the first machine wheel 8 and the machine shaft 3 and is formed as an overrun coupling which allows an overrunning by the machine shaft 3 in relation to the first machine wheel 8 in the direction of rotation of the crankshaft CR, and blocks this in the opposite direction of rotation. Such a generator overrun device, known in itself, prevents the transmission of crankshaft rotational vibrations to the electric machine M.

A controllable fourth coupling K4 is arranged between the second machine wheel 9 and the machine shaft 3 and in closed state blocks an overrunning by the machine shaft 3 in relation to the second machine wheel 9 in the direction of rotation of the crankshaft CR, and in opened state decouples the second machine wheel 9 from the machine shaft 3 in both directions of rotation. In starting, boost and stationary air-conditioning modes, coupling K4 is closed in order to transmit the rotation of the driving electric machine M to the crankshaft CR in starting and boost mode, and to the air-conditioning compressor A/C and the coolant pump WP in stationary air-conditioning mode. In normal operating mode, coupling K4 (and also coupling K2) is opened to be able to hold the second driving plane 2 at a standstill. The coupling K4 is formed as a controllable overrun coupling which in opened state allows a relative twist in both directions of rotation. Alternatively this can also be an electrically controllable magnetic coupling.

A fifth coupling K5 is arranged between the first compressor wheel 10 and the compressor shaft 4 and is formed as an overrun coupling which allows an overrunning by the compressor shaft 4 in relation to the first compressor wheel 10 in the direction of rotation of the crankshaft CR, and blocks this in the opposite direction of rotation. In stationary air-conditioning mode, the overrun function of the coupling K5 prevents the first drive plane 1, which is then at a standstill, from being driven via the compressor shaft 4.

A sixth coupling K6 is arranged between the second compressor wheel 11 and the compressor shaft 4 and is also formed as an overrun coupling. This allows an overrunning by the compressor shaft 4 in relation to the second compressor wheel 11 in the direction of rotation of the crankshaft CR, and blocks this in the opposite direction of rotation. In normal operating mode, the overrun function of coupling K6 prevents the second drive plane 2, which is then at a standstill, from being driven via the compressor shaft 4.

The rotational connection between the two pump wheels 12, 13 and the pump shaft 5 comprises a seventh overrun coupling K7 and/or an eighth overrun coupling K8 respectively, and is kinematically identical to the rotational coupling at the air-conditioning compressor A/C.

The traction drive allows the following operating modes:

a) a starting mode in which the electric machine M operated as a motor drives the crankshaft CR from a standstill until the internal combustion engine starts:
couplings K2 and K4 are closed;
the crankshaft CR is driven by the electric machine M and itself drives the first drive plane 1 via the coupling K1 and the first crankshaft wheel 2;
the translation ratios are selected with the respective diameter ratios between the first wheels 6, 8, 10, 12 and the second wheels 7, 9, 11, 13 such that when coupling K1 is closed, the first wheels each rotate more slowly than the second wheels, and consequently couplings K3, K5 and K7 are in the overrun position. Consequently the air-conditioning compressor A/C and the coolant pump WP are driven via the second drive plane 2;
the internal combustion engine starts and the electric motor M switches to generator mode, while couplings K2 and K4 are opened and the second drive plane 2 comes to a standstill.

b) a normal operating mode in which the electric machine M operated as a generator is driven by the crankshaft CR of the running internal combustion engine:
couplings K2 and K4 are opened and the second drive plane 2 is at a standstill;
the electric machine M, air-conditioning compressor A/C and coolant pump WP are driven via the first drive plane 1 when couplings K3, K5 and K7 are in the blocking position.

c) a boost mode in which the electric machine M operated as a motor drives the crankshaft CR as support while the internal combustion engine is running:
couplings K2 and K4 are closed such that the second drive plane 2 increases its rotation speed from a standstill up to the momentary crankshaft rotation speed, with mechanically and acoustically acceptable acceleration;
the crankshaft CR driven by the combustion engine is also driven by the electric motor M via the second drive plane 2.

d) a stationary air-conditioning/heating mode in which the electric machine M operated as a motor drives the air-conditioning compressor A/C and/or the coolant pump WP when the internal combustion engine is stopped:
the first drive plane 1 is at a standstill;
coupling K2 is opened and coupling K4 is closed;
couplings K4, K6 and K8 are in the clamped position and the second machine wheel 9, second compressor wheel 11 and second pump wheel 13 are driven by the electric machine M;
to start the internal combustion engine from stationary air-conditioning mode, coupling K2 is closed such that the different rotation speeds of the (initially stopped) first drive plane 1 and second drive plane 2 are synchronized with each other in a mechanically and acoustically acceptable manner. Also in regard to the rotation speed synchronization in boost mode, coupling K2 can for example have a spring mechanism which prevents a sudden torque build-up. Coupling K2 can alternatively or optionally also be a friction coupling, the friction partners of which are closed intermittently and/or by grinding to restrict the torque which can be transmitted.

e) List of Reference Numerals
1 First drive plane
2 Second drive plane
3 Machine shaft
4 Compressor shaft
5 Pump shaft
6 First crankshaft wheel
7 Second crankshaft wheel
8 First machine wheel
9 Second machine wheel
10 First compressor wheel
11 Second compressor wheel
12 First pump wheel
13 Second pump wheel
14 First traction means
15 Second traction means
CR Crankshaft
M Electric machine
A/C Air-conditioning compressor
WP Coolant pump
K1-K8 Coupling

1. A traction drive of an internal combustion engine, comprising first and second parallel drive planes and:
a first crankshaft wheel which is connectable rotationally with a crankshaft of the internal combustion engine and is arranged in the first drive plane,
a second crankshaft wheel which is connectable rotationally with the crankshaft and is arranged coaxially to the first crankshaft wheel in the second drive plane,
an electric machine, which is operable either as a generator or as a motor, with a machine shaft,
a first machine wheel which is connectable rotationally with the machine shaft and is arranged in the first drive plane in order to be driven by the crankshaft when the electric machine is in a generator mode,
a second machine wheel which is connectable rotationally with the machine shaft and is arranged coaxially to the first machine wheel in the second drive plane in order to drive the crankshaft when the electric machine is in a motor mode,
an air-conditioning compressor with a compressor shaft,
a first compressor wheel which is connectable rotationally with the compressor shaft and is arranged in the first drive plane in order to drive the air-conditioning compressor in the generator mode,
an endlessly circulating first traction element which loops around the first wheels arranged in the first drive plane,
and an endlessly circulating second traction element which loops around the second wheels arranged in the second drive plane,
a second compressor wheel is provided which is connectable rotationally with the compressor shaft and is arranged coaxially to the first compressor wheel in the second drive plane in order to drive the air-conditioning compressor in the motor mode.

2. The traction drive as claimed in claim 1, wherein
a first coupling is arranged between the first crankshaft wheel and the crankshaft and blocks an overrunning by the crankshaft in relation to the first crankshaft wheel in a direction of rotation of the crankshaft,
a controllable second coupling is arranged between the second crankshaft wheel and the crankshaft and in a closed state blocks an overrunning by the second crankshaft wheel in relation to the crankshaft in the direction of rotation of the crankshaft, and in an opened state decouples the second crankshaft wheel from the crankshaft in both directions of rotation,
a third coupling is arranged between the first machine wheel and the machine shaft and allows an overrunning by the machine shaft in relation to the first machine wheel in the direction of rotation of the crankshaft and blocks this in an opposite direction of rotation,
a controllable fourth coupling is arranged between the second machine wheel and the machine shaft and in closed state blocks an overrunning by the machine shaft in relation to the second machine wheel in the direction of rotation of the crankshaft, and in opened state decouples the second machine wheel from the machine shaft in both directions of rotation,
a fifth coupling is arranged between the first compressor wheel and the compressor shaft and allows an overrunning by the compressor shaft in relation to the first compressor wheel in the direction of rotation of the crankshaft, and blocks this in the opposite direction of rotation,
and a sixth coupling is arranged between the second compressor wheel and the compressor shaft and allows an overrunning by the compressor shaft in relation to the second compressor wheel in the direction of rotation of the crankshaft, and blocks this in the opposite direction of rotation.

3. The traction drive as claimed in claim 2, wherein the first coupling is a rigid rotational connection between the crankshaft and the first crankshaft wheel.

4. The traction drive as claimed in claim 2, wherein the controllable fourth coupling is an overrun coupling which in opened state allows an overrunning in both directions of rotation.

5. The traction drive as claimed in claim 1, wherein the traction drive furthermore comprises:
a coolant pump with a pump shaft,
a first pump wheel which can be connected is connected rotationally with the pump shaft and is arranged in the first drive plane in order to drive the coolant pump in the generator mode,
and a second pump wheel which is connected rotationally with the pump shaft and is arranged coaxially to the first pump wheel in the second drive plane in order to drive the coolant pump in the motor mode.

6. The traction drive as claimed in claim 5, wherein
a seventh coupling is arranged between the first pump wheel and the pump shaft and allows an overrunning by the pump shaft in relation to the first pump wheel in the direction of rotation of the crankshaft, and blocks this in the opposite direction of rotation,
and an eighth coupling is arranged between the second pump wheel and the pump shaft and allows an overrunning by the pump shaft in relation to the second pump wheel in the direction of rotation of the crankshaft, and blocks this in the opposite direction of rotation.

7. A method for operating a traction drive of an internal combustion engine, comprising first and second parallel drive planes and
a first crankshaft wheel which is connected rotationally with a crankshaft of the internal combustion engine and is arranged in the first drive plane,
a second crankshaft wheel which can be connected rotationally with the crankshaft and is arranged coaxially to the first crankshaft wheel in the second drive plane,
an electric machine, which is operable either as a generator or as a motor, with a machine shaft,
a first machine wheel which can be connected is connected rotationally with the machine shaft and is arranged in the first drive plane in order to be driven by the crankshaft when the electric machine is in a generator mode,
a second machine wheel which is connected rotationally with the machine shaft and is arranged coaxially to the first machine wheel in the second drive plane in order to drive the crankshaft when the electric machine is in a motor mode,
an air-conditioning compressor with a compressor shaft,
a first compressor wheel which is connected rotationally with the compressor shaft and is arranged in the first drive plane in order to drive the air-conditioning compressor in the generator mode,
a second compressor wheel which is connected rotationally with the compressor shaft and is arranged coaxially to the first compressor wheel in the second drive plane in order to drive the air-conditioning compressor in the motor mode,
an endlessly circulating first traction element which loops around the first wheels arranged in the first drive plane,
and an endlessly circulating second traction element which loops around the second wheels arranged in the second drive plane,
the method comprising operating the traction drive in at least one of the following operating modes:
a starting mode in which the electric machine operated as the motor drives the crankshaft until the internal combustion engine starts,
a normal operating mode in which the electric machine operated as the generator is driven by the crankshaft of the running internal combustion engine,
a boost mode in which the electric machine operated as the motor drives the crankshaft as support while the internal combustion engine is running,
and when the internal combustion engine is stopped, a stationary air-conditioning mode in which the electric machine operated as the motor drives the air-conditioning compressor or a coolant pump.
